(19) United States
(12) Patent Application Publication
(10) Pub. No.: US 2015/0076388 A1
(43) Pub. Date: Mar. 19, 2015

(54) PROCESS FOR PRODUCING AEROGELS

(71) Applicant: Construction Research & Technology GmbH, Trostberg (DE)

(72) Inventors: Zhizhong Cai, Limburgerhof (DE); Burkhard Walther, Garching (DE); Shane McDonnell, Lyon (FR); Michael Kutschera, Neustadt (DE)

(21) Appl. No.: 14/387,292

(22) PCT Filed: Mar. 18, 2013
(86) PCT No.: PCT/EP2013/055534

§ 371 Date: Sep. 23, 2014

(30) Foreign Application Priority Data
Mar. 30, 2012 (EP) 12162328.4

(51) Int. Cl. C01B 33/159

(52) U.S. Cl. CPC C01B 33/159
USPC 252/62; 502/439; 502/401

(57) ABSTRACT

The invention relates to a process for producing an organically modified aerogel, comprising the steps of a) reacting at least one soluble salt of an acidic or amphoteric oxygen-containing molecular anion with at least one acid to give a hydrogel, b) modifying the hydrogel with a mixture comprising a silylating agent having at least one organic radical and a nonpolar solvent, c) subcritically drying the organically modified gel, wherein the process does not comprise a step between step a) and step b) for exchange of the solvent and/or for removal of salts and the process is performed in the absence of alcohol. Additionally disclosed is the use of the organically modified aerogel obtained as a heat- or sound-insulating material, as a catalyst support, gas storage means or as an adsorbent.

The invention relates to a process for producing organically modified aerogels, wherein a soluble salt of an acidic or amphoteric oxygen-containing molecular anion is reacted with at least one acid to give a hydrogel and subsequently treated with a mixture of a silylating agent and a nonpolar solvent. The drying to give aerogels is performed under subcritical conditions. Additionally disclosed is the use of the aerogel obtained as a heat- or sound-insulating material, as a catalyst support, gas storage means or as an adsorbent.

Aerogels are high-porosity solids in which up to 99.98% of the volume consists of pores. Aerogels can be produced on the basis of various materials, silica aerogels being the most well-known. However, they can also be formed from other acidic or amphoteric oxygen-containing molecular anions, for example titanates or aluminates. Aerogels can be obtained in this case especially via a sol-gel process to form a hydrogel, and subsequent drying. The internal structure of aerogels consists of a three-dimensional structure of primary particles which fuse to one another in a disordered manner during the sol-gel synthesis. The cavities present between the particles form the pores.

It is known that hydrogels, especially silica hydrogels, which can be produced by acidifying waterglass, can be dried under supercritical conditions to form microporous (pore size <2 nm) or mesoporous (pore size between 2 and 50 nm), three-dimensionally crosslinked products. Such a product obtained by supercritical drying, in the case of gels, is called aerogel. The supercritical drying completely or substantially eliminates the interfacial tension of the fluid present in the microporous or mesoporous, three-dimensionally crosslinked gel. The aim here is to substantially avoid shrinkage of the microporous or mesoporous, three-dimensionally crosslinked gel in the course of drying, since characteristic properties of the microporous or mesoporous, three-dimensionally crosslinked gels are entirely or partly lost in the course of shrinkage. Unlike the case of conventional drying with no particular provisions, in which the gels suffer a great contraction in volume and form xerogels, drying close to the critical point thus results only in a small contraction in volume (less than 15% by volume).

The prior art for production of aerogels by means of supercritical drying is described, for example, in detail in Reviews in Chemical Engineering, Volume 5, No. 1-4, p. 157-198 (1988), in which the pioneering studies by Kistler are also mentioned.

WO-A-95 06 617 relates to hydrophobic silica aerogels which are obtainable by reacting a waterglass solution with an acid at a pH of 7.5 to 11, substantially removing ionic constituents from the hydrogel formed by washing with water or dilute aqueous solutions of inorganic bases while maintaining the pH of the hydrogel within the range from 7.5 to 11, displacing the aqueous phase present in the hydrogel by means of an alcohol and then supercritically drying the resulting alcogel.

WO-A-94 25 149 discloses first treating a gel with a hydrophobizing agent before drying it. The gel obtained as a result can be dried under subcritical conditions without causing any significant contraction in volume.

In the production of aerogels, alkoxy metallates such as tetraethyl orthosilicate or titanium tetraisopropoxide are also used very frequently as raw materials. This has the advantage that no salts, which would have to be removed subsequently, are obtained in the production of the gel. However, a great disadvantage is that alkoxy metallates are very expensive. In this context, the person skilled in the art is aware that the mechanism of sol-gel formation in the case of alkoxy metallates is fundamentally different from that of the soluble salts of an acidic or amphoteric oxygen-containing molecular anion, for instance sodium silicate (C. Jeffrey Brinker, George W. Scherer “Sol-Gel Science: The Physics and Chemistry of Sol-Gel Processing” Academic Press, 1990, page 97ff). According to the amount of water added, alkoxy metallates first form catenated structures with a low level of branching, which crosslink at a later stage. In contrast, for example, silica produced from sodium silicate and an acid polymerizes directly to give particles which become larger as a result of further polymerization and thus form the primary particles.

Hydrophobic aerogels, especially based on silicon dioxide, are already being used in exterior insulation finishing systems due to their very good insulating properties and have the advantage that they lead to a much smaller increase in width of the wall for the same insulation performance. A typical value for the thermal conductivity of silicon dioxide aerogels in air at standard pressure and 20° C. is between 0.017 and 0.021 W/(m·K). The differences in the thermal conductivity of the silicon dioxide aerogels are determined essentially by the difference in size of the pores according to the production process, which is in the range from 10 to 100 nm.

In order to produce aerogels at minimum expense on the industrial scale, suitable raw materials are especially alkali metal silicates, which are reacted with organic or inorganic acids to form the hydrogel. Especially on the industrial scale, however, it is difficult to obtain, from these favorable raw materials, hydrogels and subsequently aerogels. The alkali metal silicates are generally first desalinated with the aid of an ion exchanger and, after hydrogel formation, the gel is subjected to several wash steps and a solvent exchange. This is costly and inconvenient since the ion exchangers have to be regenerated regularly, and the wash steps are very time-consuming and produce considerable amounts of waste.

WO 2010/143902 describes a process for producing a mat comprising an aerogel. The aerogel is produced here by first reacting waterglass with an acid and then adding an alcohol. The gel thus produced is subsequently treated with a mixture of an organic silylating agent and an organic solvent. The hydrophobicized gel separates here from the aqueous phase and is used for impregnation of a matrix of fibers. However, the hydrophobicized gels obtained by this process have the disadvantage of a relatively high thermal conductivity.

It is therefore an object of the present invention to provide a procedurally flexible and economically viable process for producing aerogels based on an aqueous alkali metal silicate solution. More particularly, the number of process steps was to be reduced and the consumption of solvents minimized and an aerogel with minimum thermal conductivity provided.

This object was achieved by a process for producing an organically modified aerogel, comprising the steps of
a) reacting A) at least one soluble salt of an acidic or amphoteric oxygen-containing molecular anion with B) at least one acid to give a hydrogel,
b) modifying the hydrogel with a mixture comprising a silylating agent having at least one organic radical and at least one nonpolar solvent,
c) subcritically drying the organically modified gel,
   wherein the process does not comprise a step between step a) and step b) for exchange of the solvent and/or for removal of salts and the process is performed in the absence of alcohol.

It has been found that, surprisingly, the process according to the invention not only achieves the object stated but also gives an aerogel with a very low salt content.

The at least one acidic or amphoteric oxygen-containing molecular anion is preferably one based on aluminum, silicon, phosphorus, tin, antimony, titanium, chromium, molybdenum, tungsten, lead, bismuth, zirconium, hafnium, vanadium, niobium, tantalum, boron, arsenic, manganese, rhenium, zinc, germanium, yttrium, beryllium and copper.

In a particularly preferred embodiment, the salt of the acidic or amphoteric oxygen-containing molecular anion is at least one compound from the group of alkali metal silicate, alkali metal titanate, alkali metal aluminate and alkali metal phosphate. More particularly, the cation may be at least one from the group of sodium, potassium and ammonium. In a particularly preferred embodiment, the salt of the acidic or amphoteric oxygen-containing molecular anion is sodium silicate or potassium silicate. More preferably, the soluble salt of an acidic or amphoteric oxygen-containing molecular anion may be a 1 to 40% by weight sodium waterglass and/or potassium waterglass solution.

The acid used may preferably be at least one from the group of acetic acid, oxalic acid, trifluoroacetic acid, trichloroacetic acid, carbonic acid, methanesulphonic acid, hydrochloric acid, hydrofluoric acid, sulfuric acid, phosphoric acid, boric acid and nitric acid.

The pH of the mixture of components A) and B) plays an important role with regard to the rate of hydrogel formation. For example, in the reaction at room temperature of alkali metal silicate with organic or inorganic acids, hydrogel formation at pH 8 to 9 generally takes in the range from seconds to a few minutes, while in the pH range from 2 to 3, hydrogel formation takes hours to days. In the context of the present invention, the pH of the mixture of components A) and B) may especially have a value between 2.5 and 8, preferably between 3.5 and 7 and more preferably between 4 and 5.5. The pH can directly influence the size of the primary particles. For example, the primary particles in the case of hydrogel formation on the basis of silica, according to the pH selected, may especially be between 2 and 4 nm, and the secondary particles between 10 and 150 nm.

It is also possible to influence the rate of hydrogel formation and the primary particle size via the temperature of components A) and B) used. More particularly, the temperature of the feedstocks is between 10 and 80° C., preferably between 15 and 30° C.

When the soluble salt of an acidic or amphoteric oxygen-containing molecular anion is an alkali metal silicate, in a particularly preferred embodiment, the SiO₂ gel obtained in step a), prior to step b), can be aged at 20 to 100° C. and at a pH of 2 to 12 for up to 12 hours. The pH of the mixture of components A) and B) after leaving the surface preferably has a value between 2.5 and 8, preferably between 3.5 and 7 and more preferably between 4 and 6.

It has been found to be particularly advantageous to age the gel for a maximum of 3 hours, especially a maximum of 1.5 hours and especially preferably a maximum of 0.5 hours. This distinctly accelerates the modification of the hydrogel in step b), while simultaneously obtaining a product after the drying which features a relatively low thermal conductivity (lambda value).

In a particularly preferred embodiment, step a) can be performed in a reactor which has
α) a body K rotating about an axis of rotation and
β) a metering system,
   wherein
I) i) the at least one soluble salt of an acidic or amphoteric oxygen-containing molecular anion and
ii) the at least one acid
are applied with the aid of the metering system to an inner region of the surface of the rotating body K such that a mixture of components i) and ii) flows over the surface of the rotating body K to an outer region of the surface of the rotating body K,
II) the mixture leaves the surface.

It is particularly preferable in this context when the pH of the mixture after leaving the surface of the body K is between 2 and 12.

In an alternatively preferred embodiment, it is also possible to initially charge the acid and to introduce into it, with rapid mixing, the at least one soluble salt of an acidic or amphoteric oxygen-containing molecular anion.

In a preferred variant of the process, the gel obtained after step a) and/or a subsequent process step is comminuted. The comminution of the hydrogel enables faster modification in step b) and faster drying in step c). Suitable processes for comminution of the gel are all of those known to the person skilled in the art; more particularly, it is possible to use low-pressure extruders. In a preferred embodiment, the hydrogel is comminuted to particles having a diameter between 1.5 and 4 mm. The comminuted hydrogels are dimensionally stable in the further process steps, more particularly during the modification in step b) and the drying in step c).

In a preferred process variant, opacifiers, especially IR opacifiers, can be added to the at least one soluble salt of an acidic or amphoteric oxygen-containing molecular anion, to the at least one acid and/or to the mixture thereof prior to the formation of the hydrogel. To reduce the radiative contribution of thermal conductivity, the IR opacifiers used may especially be carbon black, activated carbon, titanium dioxide, iron oxides, zirconium dioxide or mixtures thereof.

Preferred groups of the silylating agent having at least one organic radical used in step b) are trisubstituted silyl groups of the general formula —Si(R)₃, more preferably trialkyl- and/or triarylsilyl groups, where each R is independently a nonreactive organic radical such as C₁-C₁₈-alkyl or C₆-C₁₄-aryl, preferably C₁-C₆-alkyl or phenyl, especially methyl, ethyl, cyclohexyl or phenyl, which may additionally be substituted by functional groups.

For permanent hydrophobization of the aerogel, it is particularly advantageous to use trimethylsilyl groups.

The silylating agent having at least one organic radical used in step b) may be at least one silane of the formula R¹₄₋ₙSiClₙ or R¹₄₋ₙSi(OR²)ₙ where n=1 to 3, where R¹ and R² are the same or different and are independently C₁-C₆-alkyl, cyclohexyl or phenyl.

The silylating agent having at least one organic radical used in step b) may additionally be a disiloxane of the formula R₃Si—O—SiR₃ and/or a disilazane of the formula R₃Si—N(H)—SiR₃, where the R radicals are the same or different and are each independently a hydrogen atom or a nonreactive organic, linear, branched, cyclic, saturated or unsaturated, aromatic or heteroaromatic radical, and are especially the same or different and are each independently C₁-C₆-alkyl, cyclohexyl or phenyl.

The silylating agent having at least one organic radical used in step b) is especially at least one compound from the group of hexamethyldisilazane, dimethyldichlorosilane, dimethylchlorosilane, methyltrichlorosilane, methyldichlorosilane, ethyltrimethoxysilane, ethyltriethoxysilane, triethylethoxysilane, trimethylethoxysilane, methyltrimethoxysilane, ethyltrimethoxysilane, methoxytrimethylsilane, trimethylchlorosilane and triethylchlorosilane. Particular preference is given to using hexamethyldisilazane as the silylating agent in step b).

The nonpolar solvent is preferably a solvent having a solubility in water of less than 1 g/liter, especially less than 0.5 g/liter at 20° C.

The nonpolar solvent may especially preferably be at least one hydrocarbon of the formula CₙH₂ₙ₊₂, where n is an integer from 5 to 20, preferably from 5 to 10, especially pentane, hexane, heptane, octane, nonane and decane.

In addition, the nonpolar solvent may be a halogenated hydrocarbon, especially CₙH₍₂ₙ₊₂₎₋ₘXₘ, where n is an integer from 4 to 20, m is an integer from 1 to (2n+2) and X is fluorine, chlorine, bromine or iodine.

The nonpolar solvent may also be at least one cycloalkane and/or cycloalkene, especially cyclopentane, cyclopentadiene, cyclohexane, cyclohexene, cyclooctane, cyclooctene, cyclodecane and cyclodecene.

Further useful nonpolar solvents are aromatic hydrocarbons such as toluene, benzene, xylene, mesitylene and ethylbenzene. In a further embodiment, the nonpolar solvent may also be at least one ether and/or ester, especially diethyl ether, n-butyl acetate and triglycerides (fats), which preferably has a solubility in water of less than 1 g/liter, especially less than 0.5 g/liter, at 20° C.

The mixture for modification of the hydrogel more preferably consists of a silylating agent having at least one organic radical, more preferably hexamethyldisilazane, and a nonpolar solvent, especially hexane.

The organically modified gel can be dried especially at temperatures of −b 30 to 350° C. and pressures of 0.001 to 20 bar. Especially suitable apparatuses for the drying are fluidized bed dryers, drum dryers, tumble dryers, pan dryers, screw dryers, paddle dryers, roller dryers and freeze dryers. Particular preference is given to fluidized bed dryers.

The present invention further envisages a process in which fibers are added to the at least one soluble salt of an acidic or amphoteric oxygen-containing molecular anion or to the at least one acid and/or to the mixture thereof prior to the formation of the hydrogel. The fibers preferably comprise at least one fiber from the group of inorganic fibers, such as mineral wool and glass fibers, or organic polymer fibers, for example polyester, polyolefin and/or polyamide fibers, preferably polyester fibers. The fibers may have round, trilobal, pentalobal, octalobal, ribbon, christmas-tree, dumb bell or other star-shaped profiles. It is likewise possible to use hollow fibers. The fibers here may also be in the form of a nonwoven.

In addition, the present invention provides for the use of the organically modified aerogel as a heat- or sound-insulating material, as a catalyst support, gas storage means or as an adsorbent.

### EXAMPLES

### Inventive Examples

The inventive examples which follow were performed on a rotating body K which is configured as a smooth disc and consists of aluminum. The disc is on an axis and is surrounded by a metallic housing and has a diameter of 20 cm. The disc temperature is controlled from the inside with a heat carrier oil. Comparable reactors are also described in detail in documents WO00/48728, WO00/48729, WO00/48730, WO00/48731 and WO00/48732.

### Production of Silica Hydrogel:

A 21.6% by weight waterglass solution (density: 1.189 g/ml, pH 11.75) is metered at a temperature of 20° C. onto the centre of the disc, with a flow rate of 2.00 ml/second. At the same time, a 20% by weight acidic acid solution (density: 1.025 g/ml, pH 1.88) at a temperature of 20° C. is metered onto the disc at a radial distance of one centimeter from the centre, with a flow rate of 1.80 ml/second. The disc rotates at a speed of 500 revolutions per minute and is at a controlled temperature of 20° C. The mixture is collected after leaving the disc.

pH of the resulting mixture: 5.05

Solid content: 17% by weight

Gel formation time: 14 minutes

### General Method for Modification of the Hydrogel With a Silylating Agent:

A)

The solution collected in the experiment described above is immediately transferred into a mould (length 3 cm, width 3 cm, height 3 cm), the mould being filled up to the edge. This is followed by ageing of the gel for a given time (1.5 to 24 hours). After the ageing, the resulting gel cube (about 25 g) is introduced into a 250 ml screwtop bottle. A sufficient amount of hexane (about 45 g) is added to cover the cube. Subsequently, based on the amount of hexane, 20% by weight of hexamethyldisilazane is added.

After a given time (24 hours, 48 hours or 72 hours), the gel cube is removed. The remaining mixture consists of an organic hexane phase and a water phase in which the salts are dissolved. A measuring cylinder is used to determine the volume of the water phase.

The gel cube is introduced into 100 ml of distilled water and sheared with the Ultraturrax at 20 000 revolutions per minute for 60 seconds, and left to stand for 120 minutes. In the course of this, the sodium ions still present in the gel go into solution. The suspension is filtered with suction through a black-band filter. The sample is filtered once again through a 0.45 μm syringe filter and diluted 1:40 with double-distilled water. The amount of salt washed out in the filtrate is determined by means of ICP (inductively coupled plasma) analysis. An instrument with the model name “Spectro Ciros Vision” from Spectro A. I. GmbH & Co. KG is used. This is an optical emission spectrometer with inductively coupled plasma excitation. The results are shown in Table 1.

B)

The experiment was conducted analogously to A), except that the gel cube after ageing is comminuted in a low-pressure extruder. An instrument with the model name “Dome Granulator Model DG-L1” from Fuji Paudal Co Ltd. is used. The gel cube is introduced into the intake funnel; the speed of the screw is set to 40 revolutions/minute. The extruder head consists of a dome-shaped perforated sheet with hole size 2 mm. The gel cube is comminuted in the extruder and forced through the perforated sheet so as to form cylindrical aquagel particles. The resulting particles have a diameter of about 2 mm and a length of 2 to 4 mm and are modified and treated in the same way as described above. The results are shown in Table 2.

### Typical Physical Values of the Dried Gel:

Typical physical values of an aquagel comminuted into 2 mm particles in a low-pressure extruder after ageing for 1.5 hours, which is modified with hexamethyl-disilazane for 24 hours and dried in a drying cabinet at 180° C. under reduced pressure (35 mbar):
Lambda: 17.4 mW/m·K
Pore volume: 4.02 ml/g
Pore size: 23.0 nm
Surface area: 750 m²/g

The lambda value is measured at 1024 mbar and a temperature of 23° C.

A one-plate thermal conductivity measuring instrument with the model name “Lambda-Meter EP 500” from Lambda-Meβtechnik GmbH Dresden is used. The measurement is effected to ISO 8302 or EN 12667.

The N₂ absorption and desorption is measured with an instrument with the model name “Autosorb” from Quantachrome GmbH & Co. KG.
Pore volume: 4.55 ml/g by BJH Adsorption, 4.64 BJH Desorption
BJH: Barrett, Joyner and Halenda Method
Pore size: 37.2 nm by BJH Adsorption, 17.4 nm BJH Desorption,
Average: 24.3 nm
BJH: Barrett, Joyner and Halenda Method
Surface area: 746 m²/g by Multipoint BET
BET: Brunauer-Emmett-Teller Method

TABLE 1
Hydrogel by method A)

| | | Sodium content | | | Amount of water lost | | |
|---|---|---|---|---|---|---|---|
| | HMDS | (% by wt.) after | | | (% relative to target amount) | | |
| Ageing | (% by wt.) | 24 h | 48 h | 72 h | 24 h | 48 h | 72 h |
| 24 h | 20% | 6.6 | 3.2 | 1.9 | 40.1 | 74.8 | 87.0 |
| 1.5 h | 20% | 6.3 | 2.4 | 1.3 | 59.7 | 91.2 | 99.0 |

TABLE 2
Hydrogel by method B)

| | | Sodium content | | | Amount of water lost | | |
|---|---|---|---|---|---|---|---|
| | HMDS | (% by wt.) after | | | (% relative to target amount) | | |
| Ageing | (% by wt.) | 24 h | 48 h | 72 h | 24 h | 48 h | 72 h |
| 24 h | 20% | 1.6 | 1.2 | 1.4 | 92.8 | 98.7 | 95.4 |
| 1.5 h | 20% | 0.4 | 0.9 | 0.1 | 103.0 | 99.7 | 105.5 |

### Comparative Example in Analogy to Example 1 of WO 2010/143902

### Preparation of Silica Hydrogel:

100 ml of sodium waterglass (5%) are initially charged in a 250 ml glass bottle. While stirring with a paddle stirrer at 1000 revolutions per minute, 33 ml of hydrochloric acid (1 mol/liter) are added rapidly within about 2-5 seconds. The mixture is stirred for a further 2 min and then 33 ml of ethanol are added rapidly while stirring at 1000 revolutions per minute.

### Modification of the Gel:

The resulting silica hydrogel is introduced into a screwtop bottle and covered with a 1:1 mixture of isopropanol and hexane, comprising 10% by weight of hexamethyl-disilazane, and modified for 24 hours.

The resulting product was dried in a drying cabinet at 180° C. under reduced pressure (35 mbar).

Physical values which were measured in analogy to the inventive examples:
Lambda: 55 mW/m·K
Pore volume: 0.24 ml/g
Pore size: 91.3 nm
Surface area: 103 m²/g

The experiments show that the gel obtained by the process according to the invention has a much lower thermal conductivity than the gel obtained according to the prior art.

1. A process for producing an organically modified aerogel, comprising the steps of
a) reacting A) at least one soluble salt of an acidic or amphoteric oxygen-containing molecular anion with
B) at least one acid
to give a hydrogel,
b) modifying the hydrogel with a mixture comprising a silylating agent having at least one organic radical and at least one nonpolar solvent,
(c) subcritically drying the organically modified gel, characterized in that the process does not comprise a step between step a) and step b) for exchange of the solvent and/or for removal of salts and the process is performed in the absence of alcohol.

2. The process according to claim 1, characterized in that the at least one acidic or amphoteric oxygen-containing molecular anion is one based on aluminum, silicon, phosphorus, tin, antimony, titanium, chromium, molybdenum, tungsten, lead, bismuth, zirconium, hafnium, vanadium, niobium, tantalum, boron, arsenic, manganese, rhenium, zinc, germanium, yttrium, beryllium and copper.

3. The process according to claim 1, characterized in that the salt of the acidic or amphoteric oxygen-containing molecular anion is at least one compound from the group of alkali metal silicate, alkali metal titanate, alkali metal aluminate and alkali metal phosphate.

4. The process according to claim 1, characterized in that the soluble salt of an acidic or amphoteric oxygen-containing molecular anion is a 1 to 40% by weight sodium waterglass and/or potassium waterglass solution.

5. The process according to claim 1, characterized in that the acid used is at least one from the group of acetic acid, oxalic acid, trifluoroacetic acid, trichloroacetic acid, carbonic acid, methanesulphonic acid, hydrochloric acid, hydrofluoric acid, sulfuric acid, phosphoric acid, boric acid and nitric acid.

6. The process according to claim 1, characterized in that the hydrogel obtained in step a), prior to step b), is aged at 20 to 100° C. and at a pH of 2 to 12 for up to 12 hours.

7. The process according to claim 1, characterized in that the silylating agent having at least one organic radical is at least one compound from the group of hexamethyldisilazane, dimethyldichlorosilane, dimethylchlorosilane, methyltrichlorosilane, methyldichlorosilane, ethyltrimethoxysilane, ethyltriethoxysilane, triethylethoxysilane, trimethylethoxysilane, methyltrimethoxysilane, ethyltrimethoxysilane, methoxytrimethylsilane, trimethylchlorosilane and triethylchlorosilane.

8. The process according to claim 1, characterized in that the nonpolar solvent is at least one hydrocarbon of the formula CₙH₂ₙ₊₂, where n is an integer from 5 to 20.

9. The process according to claim 1, characterized in that the mixture for modification of the hydrogel consists of a silylating agent having at least one organic radical and a nonpolar solvent.

10. The process according to claim 1, characterized in that step a) is performed in a reactor which has
α) a body K rotating about an axis of rotation and
β) a metering system,
wherein
I) i) the at least one soluble salt of an acidic or amphoteric oxygen-containing molecular anion and
ii) the at least one acid
are applied with the aid of the metering system to an inner region of the surface of the rotating body K such that a mixture of components i) and ii) flows over the surface of the rotating body K to an outer region of the surface of the rotating body K, and
II) the mixture leaves the surface.

11. The process according to claim 1, characterized in that fibers are added to the at least one soluble salt of an acidic or amphoteric oxygen-containing molecular anion or to the at least one acid and/or to the mixture thereof prior to the formation of the hydrogel.

12. The process according to claim 1, characterized in that opacifiers, optionally IR opacifiers, are added to the at least one soluble salt of an acidic or amphoteric oxygen-containing molecular anion or to the at least one acid and/or to the mixture thereof prior to the formation of the hydrogel.

13. The process according to claim 1, characterized in that the gel obtained after step a) and/or a subsequent process step is comminuted.

14. A method of utilizing the organically modified aerogel obtained according to claim 1 as a heat-insulating or sound-insulating material, as a catalyst support, gas storage means or as an adsorbent.
